(19) United States
(12) Patent Application Publication
(10) Pub. No.: US 2025/0178681 A1
(43) Pub. Date: Jun. 5, 2025

(54) TRACK SYSTEM FOR TRACTION OF A VEHICLE

(71) Applicant: CAMSO INC., Magog (CA)

(72) Inventors: Jean TURCOTTE, Sherbrooke (CA); Dewaine KAUTSCH, Jefferson City, MO (US); Jeffrey DANIELS, Magog (CA); Francois LEBLANC, Magog (CA)

(73) Assignee: CAMSO INC., Magog, QC (CA)

(21) Appl. No.: 18/842,494

(22) PCT Filed: Mar. 3, 2023
(86) PCT No.: PCT/CA2023/050278

§ 371 Date: Aug. 29, 2024

Related U.S. Application Data
(60) Provisional application No. 63/316,387, filed on Mar. 3, 2022.

(51) Int. Cl. B62D 55/30

(52) U.S. Cl. CPC B62D 55/30

(57) ABSTRACT

A track system for a vehicle (e.g., an agricultural vehicle), wherein the track system is configured to provide an indication that is representative of a pressure of a hydraulic fluid inside a tensioner while reducing oil leeks, oil contamination and improving durability of the track system. For instance, the track system includes a track that comprises a ground-engaging outer surface and an inner surface opposite to the ground-engaging outer surface, a track-engaging assembly configured to drive and guide the track around the track-engaging assembly and comprising a plurality of track-contacting wheels, a tensioner configured to control a tension of the track, and an indicator configured to convey an indication that is representative of a pressure of a hydraulic fluid inside the tensioner without contacting the hydraulic fluid.

### PRIOR APPLICATION

The present application claims priority from U.S. provisional patent application No. 63/316,387, filed on Mar. 3, 2022, and entitled “TRACK SYSTEM FOR TRACTION OF A VEHICLE”, the disclosure of which being hereby incorporated by reference in its entirety.

### FIELD

This disclosure relates generally to vehicles and, more particularly, to vehicles comprising track systems for traction.

### BACKGROUND

Certain vehicles, including industrial vehicles such as agricultural vehicles (e.g., harvesters, combines, tractors, etc.), construction vehicles (e.g., excavators, bulldozers, loaders, etc.), and forestry vehicles (e.g., feller-bunchers, tree chippers, knuckleboom loaders, etc.), military vehicles (e.g., combat engineering vehicles (CEVs), etc.), snowmobiles, and all-terrain vehicles (ATVs), for example, may be equipped with track systems to enhance their traction and floatation on soft, slippery and/or irregular grounds (e.g., soil, mud, sand, ice, snow, etc.) on which they operate.

A vehicle's track system comprises a track-engaging assembly and a track that is driven around the track-engaging assembly, which may include a frame, track-contacting wheels, a tensioner for tensioning the track, etc. The track system is typically designed taking into consideration how, where, and when the vehicle will be used (e.g., in agricultural fields, on roads, in trails, at construction sites, etc.). For example, in some conventional track systems, to indicate a load of the tensioner, the tensioner can include an indicator or sensor that receives or comes into contact with oil from the tensioner and is configured to indicate whether the oil pressure in the tensioner is appropriate. However, such conventional indicators or sensors are prone to oil leaks and/or become ineffective when oil from the tensioner gets soiled with dust or debris. Moreover, operating conditions of the vehicle (e.g., speeds, loads, ground characteristics, uses/applications, etc.) can vary, sometimes significantly, and the track system may not perform optimally under all these conditions (e.g., due to trade-offs and other decisions made during its design).

For these and other reasons, improvements for track systems of vehicles would be welcomed.

### SUMMARY

According to various aspects, this disclosure relates to a track system for a vehicle (e.g., an agricultural vehicle), wherein the track system is configured to provide an indication that is representative of a pressure of a hydraulic fluid inside a tensioner while reducing oil leeks, oil contamination and improving durability of the track system. For instance, the track system includes a track that comprises a ground-engaging outer surface and an inner surface opposite to the ground-engaging outer surface, a track-engaging assembly configured to drive and guide the track around the track-engaging assembly and comprising a plurality of track-contacting wheels, a tensioner configured to control a tension of the track, and an indicator configured to convey an indication that is representative of a pressure of a hydraulic fluid inside the tensioner without contacting the hydraulic fluid.

For example, according to a first aspect, there is provided a track system for a vehicle. The track system comprises: a track that comprises a ground-engaging outer surface and an inner surface opposite to the ground-engaging outer surface; a track-engaging assembly configured to drive and guide the track around the track-engaging assembly and comprising a plurality of track-contacting wheels; a tensioner configured to control a tension of the track, the tensioner comprising a hydraulic cylinder and a hydraulic accumulator in fluid communication with the hydraulic cylinder and configured to receive hydraulic fluid; and an indicator configured to indicate a load of the tensioner and being free of contact with the hydraulic fluid.

In some embodiments, the indicator comprises a body and the tensioner and the tensioner is configured to exert one of: a force, a moment, and a pressure on the body.

In some embodiments, the tensioner comprises: a first anchor at a first end of the hydraulic cylinder and being attached to a first part of the track-engaging assembly; and a second anchor at a second end of the hydraulic cylinder and being attached to a second part of the track-engaging assembly, the second part of the track-engaging assembly being moveable relative to the first part of the track-engaging assembly; and the indicator is located at a given one of the first anchor and the second anchor of the tensioner.

In some embodiments, the body comprises a bolt.

In some embodiments, the indicator comprises a surface that is visible from an exterior of the bolt and that is configured to change color depending on a load of the bolt.

In some embodiments, the bolt attaches the given one of the first anchor and the second anchor of the tensioner to the corresponding part of the track-engaging assembly.

In some embodiments, the tensioner comprises a resilient portion configured to resiliently deform under pressure of the tensioner.

In some embodiments, the hydraulic cylinder comprises: a first anchor at a first end of the hydraulic cylinder and being attached to a first part of the track-engaging assembly; and a second anchor at a second end of the hydraulic cylinder and being attached to a second part of the track-engaging assembly, the second part of the track-engaging assembly being moveable relative to the first part of the track-engaging assembly.

In some embodiments, the first part of the track-engaging assembly comprises a frame of the track-engaging assembly and the indicator comprises a gap between: a first portion of the frame attached to the first anchor and resiliently deformable; and a second portion of the frame.

In some embodiments, the indicator comprises a spring in the gap.

In some embodiments, the track system further comprises a sensor in communication with the indicator and configured to sense a parameter of the track system.

In some embodiments, the sensor is a pressure sensor.

In some embodiments, the sensor is one of a load cell and a load pin.

In some embodiments, the sensor is an accelerometer.

In some embodiments, the sensor is a strain gauge.

In some embodiments, the sensor is a force sensor.

In some embodiments, the sensor is a first sensor and the track system comprises a plurality of sensors.

In some embodiments, measurements of the sensors are weighted.

In some embodiments, the sensor is connected to the indicator wirelessly.

In some embodiments, the indicator comprises a light device.

In some embodiments, the light device is a LED.

In some embodiments, the indicator comprises a speaker device.

In some embodiments, the indicator is provided on a user interface of the vehicle.

In some embodiments, the user interface of the vehicle is located in an operator cabin of the vehicle.

In some embodiments, the indicator is provided on a display device.

In some embodiments, the display device comprises one of: a computer; a smart phone; and a tablet.

In some embodiments, the hydraulic fluid comprises oil.

In some embodiments, the tensioner comprises a channel connecting the hydraulic cylinder with the hydraulic accumulator and the channel is filled with the hydraulic fluid.

In some embodiments, the hydraulic accumulator comprises a housing which comprises: an accumulation chamber; a piston moveable relative to the housing; and a compressible chamber formed by the housing and the piston and comprising a biasing element to exert a force against the piston.

In some embodiments, the biasing element comprises a spring.

In some embodiments, the biasing element comprises a compressible fluid.

In some embodiments, the compressible fluid comprises nitrogen.

In some embodiments, the compressible chamber hermetically contains the compressible fluid.

In some embodiments, the tensioner is configured to apply a tension on the track at a nominal tension value of at least 1500 psi.

In some embodiments, the tensioner is configured to apply a tension on the track at a nominal tension value of at least 2000 psi.

In some embodiments, the tensioner is configured to apply a tension on the track at a nominal tension value of at least 2500 psi.

As another example, according to another aspect, there is provided a track system for a vehicle. The track system comprises: a track that comprises a ground-engaging outer surface and an inner surface opposite to the ground-engaging outer surface; a track-engaging assembly configured to drive and guide the track around the track-engaging assembly and comprising a plurality of track-contacting wheels; a tensioner configured to control a tension of the track, the tensioner comprising a hydraulic cylinder and a hydraulic accumulator in fluid communication with the hydraulic cylinder and configured to receive hydraulic fluid; and an indicator configured to convey information related to a static pressure of the tensioner based on a measurement that is different from a measurement of the static pressure of the tensioner.

According to a another aspect, there is provided a track system for a vehicle, the track system comprising: a track that comprises a ground-engaging outer surface and an inner surface opposite to the ground-engaging outer surface; a track-engaging assembly comprising a plurality of track-contacting wheels configured to drive and guide the track around the track-engaging assembly; a tensioner configured to control a tension of the track, the tensioner comprising a hydraulic cylinder and a hydraulic accumulator in fluid communication with the hydraulic cylinder and configured to receive hydraulic fluid; and an indicator configured to indicate a load of the tensioner and being free of contact with the hydraulic fluid.

In some embodiments, the hydraulic cylinder comprises: a first anchor at a first end of the hydraulic cylinder and being coupled to a first part of the track-engaging assembly; and a second anchor at a second end of the hydraulic cylinder and being coupled to a second part of the track-engaging assembly, the second part of the track-engaging assembly being moveable relative to the first part of the track-engaging assembly.

In some embodiments, the indicator is located at a given one of the first anchor and/or the second anchor of the tensioner.

In some embodiments, the indicator comprises a body and the tensioner is configured to exert one of: a force, a moment, and a pressure on the body; or the indicator comprises a resilient portion configured to resiliently deform when a pressure, a load, or a moment is applied on the resilient portion.

In some embodiments, the indicator comprises the body and the body comprises a bolt comprising a surface that is visible from an exterior of the bolt and that is configured to change color depending on the load of the bolt.

In some embodiments, the bolt couples the given one of the first anchor and/or the second anchor of the tensioner to a corresponding part of the track-engaging assembly.

In some embodiments, the first part of the track-engaging assembly comprises a frame of the track-engaging assembly and the indicator comprises a gap between: a first portion of the frame that is coupled to the first anchor and resiliently deformable and a second portion of the frame.

In some embodiments, the indicator comprises a spring in the gap.

In some embodiments, the track system further comprises at least one sensor in communication with the indicator and configured to sense a parameter of the track system, wherein the at least one sensor is at least one of: a pressure sensor, a load cell, a load pin, an accelerometer, a strain gauge, and a force sensor.

In some embodiments, the tensioner further comprises a channel to fluidly connect the hydraulic cylinder with the hydraulic accumulator.

In some embodiments, the hydraulic accumulator comprises a housing, wherein the housing comprises: an accumulation chamber, a piston moveable relative to the housing, a compressible chamber formed by the housing and the piston, and a biasing element to exert a force against the piston.

In some embodiments, the biasing element comprises a spring or a compressible fluid.

In some embodiments, the compressible chamber hermetically contains the compressible fluid and the compressible fluid comprises nitrogen.

In some embodiments, the tensioner is configured to apply the tension on the track at a nominal tension value of at least 1500 psi, at least 2000 psi, or at least 2500 psi.

In some embodiments, the indicator is configured to convey information related to a static pressure of the tensioner based on a measurement that is different from a measurement of the static pressure of the tensioner.

These and other aspects of this disclosure will now become apparent to those of ordinary skill in the art upon review of the following description of embodiments in conjunction with the accompanying drawings.

### BRIEF DESCRIPTION OF THE DRAWINGS

A detailed description of embodiments is provided below, by way of example only, with reference to the accompanying drawings, in which:

FIG. 1 shows a perspective front view of an example of an agricultural vehicle comprising a track system according to one embodiment;

FIG. 2 shows a side view of an example of an agricultural vehicle comprising a track system according to another embodiment;

FIG. 3 shows a perspective view of a track of a given one of the track systems according to one embodiment;

FIG. 4 shows a side view of the track shown in FIG. 3;

FIG. 5 shows a top view of the track shown in FIG. 3;

FIG. 6 shows a cross-sectional view of the track shown in FIG. 4, taken at line FIG. 6-FIG. 6;

FIG. 7 shows an inner view of a portion of the track shown in FIG. 3;

FIG. 8 shows a perspective view of a drive/guide projection of the track shown in FIG. 3;

FIG. 9 shows a drive wheel of a track-engaging assembly of a track system according to one embodiment;

FIG. 10 shows mid-rollers of the track-engaging assembly engaging an inner side of the track shown in FIG. 3;

FIG. 11 shows a tensioner of a track system according to one embodiment;

FIG. 12 shows a side view of a portion of a track system according to one embodiment;

FIG. 13 shows a cross-sectional view of an indicator of a track system according to one embodiment;

FIG. 14 shows a top view of the indicator shown in FIG. 13;

FIG. 15 is an enlarged view of the portion of the track system shown in FIG. 12;

FIG. 16 shows an arrangement of an anchor of the tensioner shown in FIG. 13, and a bracket of a frame of a track system according to one embodiment;

FIG. 17 shows a segment of a tensioner channel including an indicator according to another embodiment;

FIG. 18 shows a cross-sectional view of the segment of the tensioner channel shown in FIG. 17;

FIG. 19 shows a side view of a portion of a track system according to another embodiment;

FIG. 20 is a block diagram of a processing apparatus according to one embodiment;

FIG. 21 is a block diagram of a processing apparatus according to another embodiment;

FIG. 22 is a block diagram of an interface according to one embodiment;

FIG. 23 is a block diagram of a processing apparatus according to another embodiment;

FIG. 24 is a block diagram of a communication device according to one embodiment;

FIG. 25 is a block diagram of a user interface according to one embodiment;

FIG. 26 is a process flow chart of a processing apparatus and a communication device according to one embodiment;

FIG. 27 is a block diagram of a user interface according to one embodiment;

FIG. 28 shows an enlarged side view of a track system according to another embodiment, showing a load pin;

FIG. 29 shows a front view of the load pin shown in FIG. 28;

FIG. 30 shows an enlarged side view of a track system according to another embodiment, showing a strain gauge;

FIG. 31 shows a side view of an example of an agricultural vehicle comprising a track system according to another embodiment, showing accelerometers embedded in the track;

FIG. 32 shows a perspective side view of a track system according to another embodiment, showing strain gauges connected to cables of the track;

FIG. 33 shows a portion of a track according to one embodiment;

FIG. 34 shows a perspective back view of an example of an agricultural vehicle comprising four track systems according to another embodiment;

FIG. 35 shows a side view of a track system according to another embodiment; and

FIG. 36 shows an example of a trailed vehicle configured to be attached to an agricultural vehicle.

It is to be expressly understood that the description and drawings are only for purposes of illustrating certain embodiments and are an aid for understanding. They are not intended to and should not be limiting.

### DETAILED DESCRIPTION OF EMBODIMENTS

The present disclosure relates to track systems comprising a track, a track-engaging assembly configured to drive and guide the track, a tensioner configured to control a tension of the track, and an indicator configured to provide a representation of a load, a pressure, or a moment of the tensioner. The tensioner can be a hydraulic cylinder and a hydraulic accumulator in fluid communication with the hydraulic cylinder and configured to receive hydraulic fluid. By monitoring and controlling the load, pressure or moment of the tensioner, a proper level of tension in the track can be maintained to ensure adequate function of the track system and avoid a derailing of the track, accelerated wear of the track's drive lugs, a loss of control of the vehicle, and/or ratcheting.

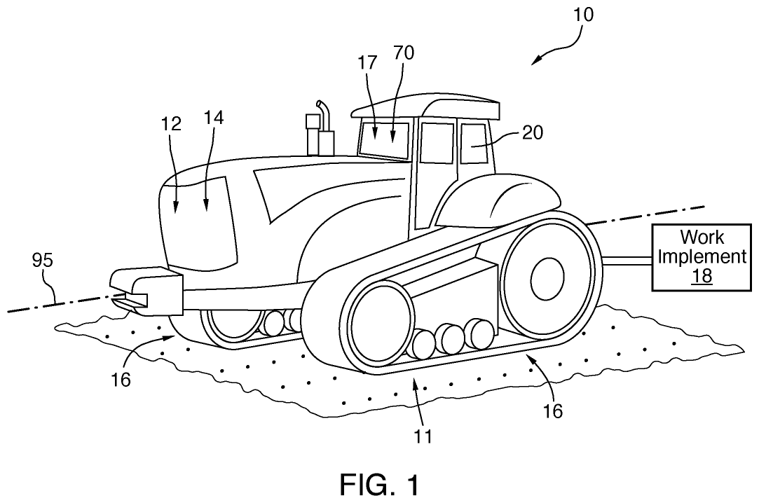

FIG. 1 shows an embodiment of a vehicle 10 comprising track systems 16 including tracks 22 for traction of the vehicle 10 on a ground. In this embodiment, the vehicle 10 is an agricultural vehicle for performing agricultural work on an agricultural field 11. Specifically, in this example, the agricultural vehicle 10 is a tractor and the agricultural field 11 comprises soil. In other examples, the agricultural vehicle 10 may be a combine harvester, another type of harvester, or any other type of agricultural vehicle.

The agricultural vehicle 10 comprises a frame 12, a powertrain 15, the track systems 16 (which can be referred to as “undercarriages”), and an operator cabin 20 that enable an operator to move the agricultural vehicle 10 on the ground. The vehicle 10 can travel on the agricultural field to perform agricultural work using a work implement 18. The vehicle 10 can also be “roading”, i.e., travelling on a road (i.e., a paved road having a hard surface of asphalt, concrete, gravel, or other pavement), such as between agricultural fields.

In this embodiment, as further discussed later, the track systems 16 are configured to provide an indication that is representative of a pressure of a hydraulic fluid 99 inside a tensioner 95 while reducing oil leeks, oil contamination and improving durability of the track systems 16.

The powertrain 15 is configured for generating motive power and transmitting motive power to the track systems 16 to propel the agricultural vehicle 10 on the ground. To that end, the powertrain 15 comprises a prime mover 14, which is a source of motive power that comprises one or more motors. For example, in this embodiment, the prime mover 14 comprises an internal combustion engine. In other embodiments, the prime mover 14 may comprise another type of motor (e.g., an electric motor) or a combination of different types of motor (e.g., an internal combustion engine and an electric motor). The prime mover 14 is in a driving relationship with the track systems 16. That is, the powertrain 15 transmits motive power generated by the prime mover 14 to one or more of the track systems 16 in order to drive (i.e., impart motion to) these one or more of the track systems 16. The powertrain 15 may transmit power from the prime mover 14 to the track systems 16 in any suitable way. In this embodiment, the powertrain 15 comprises a transmission between the prime mover 14 and final drive axles 561, 562 for transmitting motive power from the prime mover 14 to the track systems 16. The transmission may be an automatic transmission (e.g., a continuously variable transmission (CVT)) or any other suitable type of transmission.

The work implement 18 is used to perform agricultural work. For example, in some embodiments, the work implement 18 may be a combine head, a cutter, a scraper pan, a tool bar, a planter, or any other type of agricultural work implement.

The operator cabin 20 is where the operator sits and controls the agricultural vehicle 10. More particularly, the operator cabin 20 comprises a user interface 70 including a set of controls that allow the operator to steer the agricultural vehicle 10 on the ground and operate the work implement 18. For example, in this embodiment, the user interface 70 comprises an accelerator, a brake control, and a steering device that are operable by the operator to control motion of the agricultural vehicle 10 on the ground and operation of the work implement 18. The user interface 70 also comprises an instrument panel (e.g., a dashboard) which provides indicators (e.g., a speedometer indicator, a tachometer indicator, etc.) to convey information to the operator.

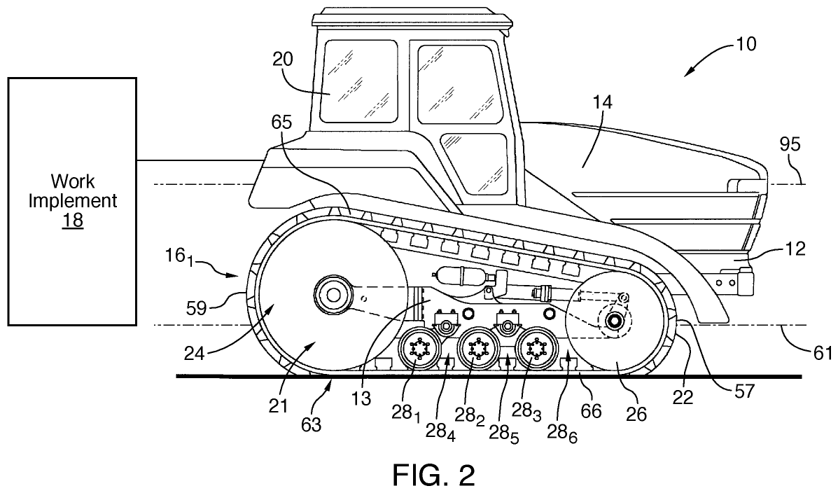

The track systems 16 engage the ground to propel the agricultural vehicle 10. As shown in FIG. 2, each track system 16 comprises a track-engaging assembly 21 and a track 22 disposed around the track-engaging assembly 21. In this embodiment, the track-engaging assembly 21 comprises a plurality of track-contacting wheels which, in this example, includes a drive wheel 24 at a first longitudinal end portion of the track system 16, and a plurality of idler wheels that includes front (i.e., leading) idler wheel 26 at a second longitudinal end portion of the track system 16 opposite to the first longitudinal end portion and a plurality of roller wheels 28₁-28₆. The track system 16 also comprises a frame 13 which supports various components of the track system 16, including the wheels 26, 28₁-28₆. The track system 16 has a longitudinal direction and a first longitudinal end 57 and a second longitudinal end 59 that define a length of the track system 16 along a longitudinal axis 61 that defines the longitudinal direction of the track system 16. The track system 16 has a widthwise direction and a width that is defined by a width WT of the track 22. The track system 16 also has a heightwise direction that is normal to its longitudinal direction and its widthwise direction.

Each of the front ones of the track systems 16 is steerable by the steering system 17 of the agricultural vehicle 10 in response to input of the user at the steering device to change an orientation of that track system relative to the frame 12 of the agricultural vehicle 10 in order to steer the agricultural vehicle 10 on the ground. To that end, each of the front ones of the track systems 16 is pivotable about a steering axis 25 of the agricultural vehicle 10. An orientation of the longitudinal axis 61 of each of the front ones of the track systems 16 is thus adjustable relative to a longitudinal axis 95 of the agricultural vehicle 10.

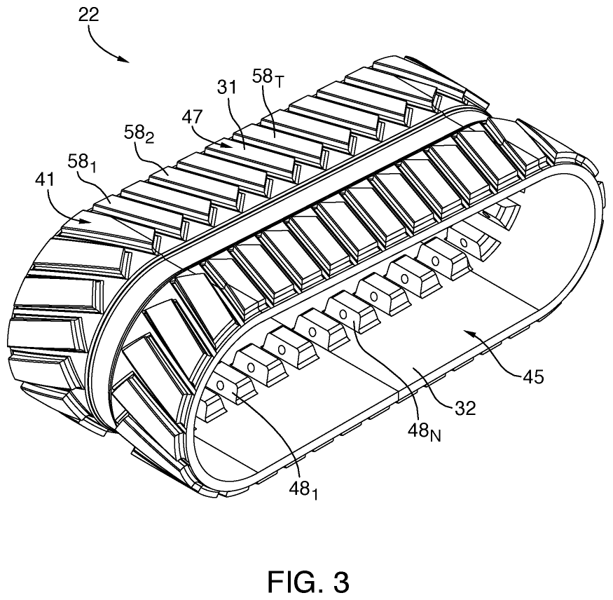

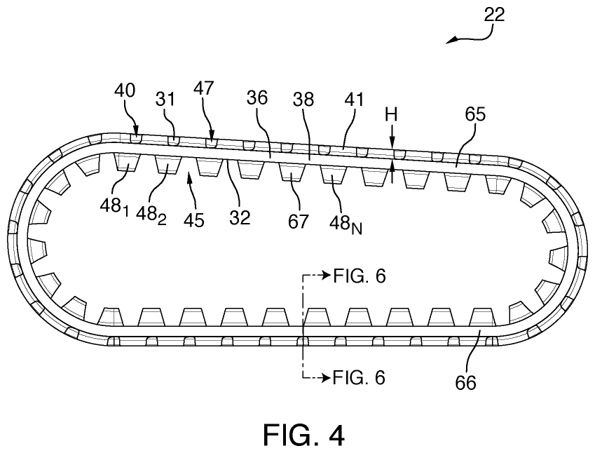

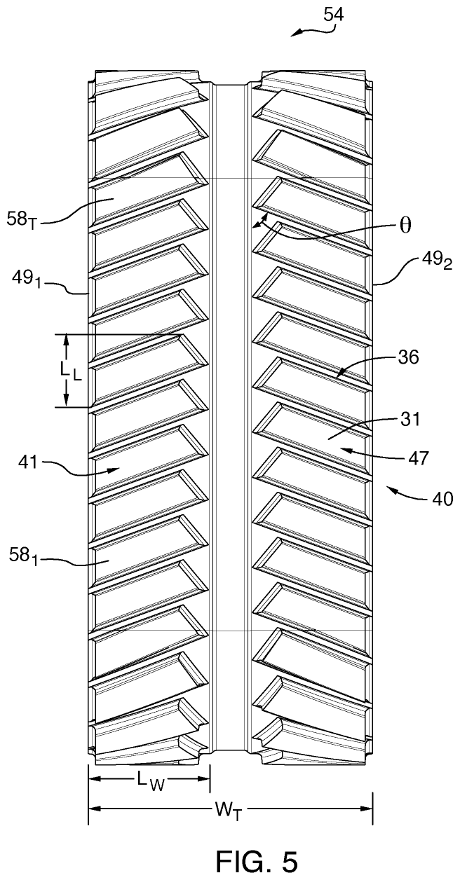

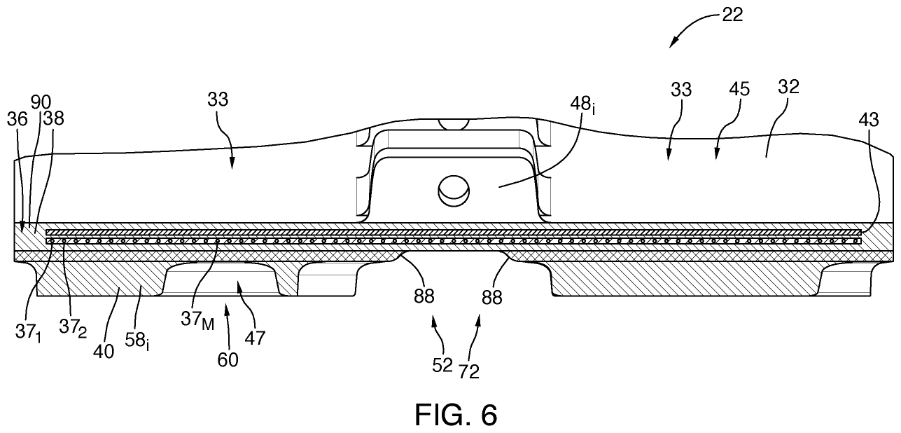

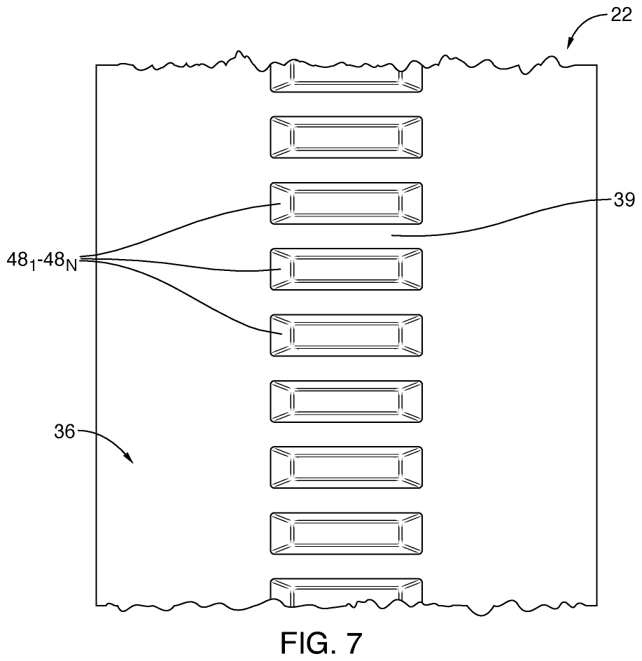

The track 22 engages the ground to provide traction to the agricultural vehicle 10. A length of the track 22 allows the track 22 to be mounted around the track-engaging assembly 21. In view of its closed configuration without ends that allows it to be disposed and moved around the track-engaging assembly 21, the track 22 can be referred to as an “endless” track. With additional reference to FIGS. 3 to 7, the track 22 comprises an inner side 45, a ground-engaging outer side 47, and lateral edges 491, 492. The inner side 45 faces the wheels 24, 26, 28₁-28₆, while the ground-engaging outer side 47 engages the ground. A top run 65 of the track 22 extends between the longitudinal ends 57, 59 of the track system 16 and over the wheels 24, 26, 28₁-28₆, while a bottom run 66 of the track 22 extends between the longitudinal ends 57, 59 of the track system 16 and under the wheels 24, 26, 28₁-28₆. The bottom run 66 of the track 22 defines an area of contact 63 of the track 22 with the ground which generates traction and bears a majority of a load on the track system 16, and which will be referred to as a “contact patch” of the track 22 with the ground. The track 22 has a longitudinal axis 19 which defines a longitudinal direction of the track 22 (i.e., a direction generally parallel to its longitudinal axis) and transversal directions of the track 22 (i.e., directions transverse to its longitudinal axis), including a widthwise direction of the track 22 (i.e., a lateral direction generally perpendicular to its longitudinal axis). The track 22 has a thickness direction normal to its longitudinal and widthwise directions.

In this embodiment, the track 22 is relatively wide to efficiently distribute load of the vehicle 10 over the soil. For instance, in some embodiments, the width W_{T} of the track 22 may be at least 24 inches, in some cases at least 36 inches, in some cases at least 48 inches, in some cases even more.

The track 22 is elastomeric, i.e., comprises elastomeric material, to be flexible around the track-engaging assembly 21. The elastomeric material of the track 22 can include any polymeric material with suitable elasticity. In this embodiment, the elastomeric material of the track 22 includes rubber. Various rubber compounds may be used and, in some cases, different rubber compounds may be present in different areas of the track 22. In other embodiments, the elastomeric material of the track 22 may include another elastomer in addition to or instead of rubber (e.g., polyurethane elastomer).

More particularly, the track 22 comprises an endless body 36 underlying its inner side 45 and ground-engaging outer side 47. In view of its underlying nature, the body 36 will be referred to as a “carcass”. In this embodiment, the carcass 36 comprises a base 90. The carcass 36 and the base 90 thereof are elastomeric in that the base 90 comprises elastomeric material 38 which allows the carcass 36 to elastically change in shape and thus the track 22 to flex as it is in motion around the track-engaging assembly 21.

In this embodiment, the carcass 36 comprises a plurality of reinforcements. Specifically, in this embodiment, the base of the carcass 36 comprises a plurality of reinforcements embedded in its elastomeric material 38 and spaced from one another. These reinforcements can take on various forms, such as reinforcing layers.

For example, in this embodiment, the base 90 of the carcass 36 comprises a layer of reinforcing cables 37₁-37_{M} that are adjacent to one another and extend generally in the longitudinal direction of the track 22 to enhance strength in tension of the track 22 along its longitudinal direction. In this case, each of the reinforcing cables 37₁-37_{M} is a cord including a plurality of strands (e.g., textile fibers or metallic wires). In other cases, each of the reinforcing cables 37₁-37_{M} may be another type of cable and may be made of any material suitably flexible along the cable's longitudinal axis (e.g., fibers or wires of metal, plastic or composite material).

As another example, in this embodiment, the base 90 of the carcass 36 comprises a layer of reinforcing fabric 43. The reinforcing fabric 43 comprises thin pliable material made usually by weaving, felting, knitting, interlacing, or otherwise crossing natural or synthetic elongated fabric elements, such as fibers, filaments, strands and/or others, such that some elongated fabric elements extend transversally to the longitudinal direction of the track 22 to have a reinforcing effect in a transversal direction of the track 22. For instance, the reinforcing fabric 43 may comprise a ply of reinforcing woven fibers (e.g., nylon fibers or other synthetic fibers).

The carcass 36 may be molded into shape in a molding process during which the rubber 38 is cured. For example, in this embodiment, a mold may be used to consolidate layers of rubber providing the rubber 38 of the carcass 36, the reinforcing cables 37₁-37_{M} and the layer of reinforcing fabric 43.

The inner side 45 of the endless track 22 comprises an inner surface 32 of the carcass 36 and a plurality of wheel-contacting projections 48₁-48_{N} that project from the inner surface 32 and are positioned to contact at least some of the wheels 24, 26, 28₁-28₆ to do at least one of driving (i.e., imparting motion to) the track 22 and guiding the track 22. The wheel-contacting projections 48₁-48_{N} can be referred to as “wheel-contacting lugs”. Furthermore, since each of them is used to do at least one of driving the track 22 and guiding the track 22, the wheel-contacting lugs 48₁-48_{N} can be referred to as “drive/guide projections” or “drive/guide lugs”. In some examples of implementation, a drive/guide lug 48ᵢ may interact with the drive wheel 24 to drive the track 22, in which case the drive/guide lug 48ᵢ is a drive lug. In other examples of implementation, a drive/guide lug 48ᵢ may interact with the idler wheel 26 and/or the roller wheels 28₁-28₆ to guide the track 22 to maintain proper track alignment and prevent de-tracking without being used to drive the track 22, in which case the drive/guide lug 48ᵢ is a guide lug. In yet other examples of implementation, a drive/guide lug 48ᵢ may both (i) interact with the drive wheel 24 to drive the track and (ii) interact with the idler wheel 26 and/or the roller wheels 28₁-28₆ to guide the track 22 to maintain proper track alignment and prevent de-tracking, in which case the drive/guide lug 48ᵢ is both a drive lug and a guide lug.

In this embodiment, the drive/guide lugs 48₁-48_{N} interact with the drive wheel 24 in order to cause the track 22 to be driven, and also interact with the idler wheel 26 and the roller wheels 28₁-28₆ in order to guide the track 22 as it is driven by the drive wheel 24 to maintain proper track alignment and prevent de-tracking. The drive/guide lugs 48₁-48_{N} are thus used to both drive the track 22 and guide the track 22 in this embodiment.

In this example of implementation, the drive/guide lugs 48₁-48_{N} are arranged in a single row disposed longitudinally along the inner side 45 of the track 22. The drive/guide lugs 48₁-48_{N} may be arranged in other manners in other examples of implementation (e.g., in a plurality of rows that are spaced apart along the widthwise direction of the track 22).

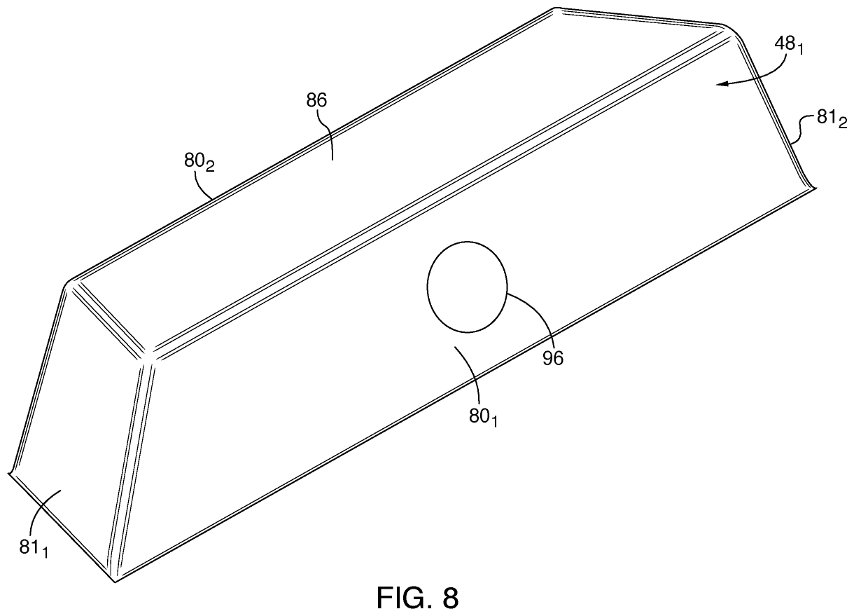

The drive/guide lugs 48₁-48_{N} may have any suitable shape. With additional reference to FIG. 8, each drive/guide lug 48ᵢ has a periphery 69 which, in this embodiment, includes a front surface 80₁, a rear surface 80₂, two lateral surfaces 81₁, 8₁₂, and a top surface 86. The front surface 80₁ and the rear surface 80₂ are opposed to one another along the longitudinal direction of the track 22. In this embodiment where the drive/guide lug 48ᵢ is used to drive the track 22, each of the front surface 80₁ and the rear surface 80₂ constitutes a drive surface which can be contacted by a drive member of the drive wheel 24 that pushes against it to impart motion to the track 22. The two lateral surfaces 81₁, 8₁₂are laterally opposed and may contact the roller wheels 28₁-28₆, the drive wheel 24 and/or the idler wheel 26 such as to prevent excessive lateral movement of the track 22 relative the wheels and to thus prevent de-tracking. In this embodiment, the drive/guide lug 48ᵢ further comprises an aperture 96 which reduces a weight of the drive/guide lug 48ᵢ and consequently reduces a weight of the track 21 and diminishes manufacturing cost of the track 21. In this example, the aperture 96 is a circular aperture extending from the front surface 80₁ to the rear surface 80₂ at a mid-distance between the lateral surfaces 81₁, 8₁₂. Although it has a certain shape in this embodiment, the periphery 69 of the drive/guide lug 48ᵢ may have various other shapes in other embodiments.

In this embodiment, the drive/guide lug 48ᵢ is configured to interact with the idler wheel 26 and/or the roller wheels 28₁-28₆ when they are aligned with one another, such that the lateral surfaces 81₁, 8₁₂of each drive/guide lug 48ᵢ face respecting ones of the roller wheels 28₁-28₆ when they are aligned with one another.

In this embodiment, each drive/guide lug 48ᵢ is an elastomeric drive/guide lug in that it comprises elastomeric material 67. The elastomeric material 67 can be any polymeric material with suitable elasticity. More particularly, in this embodiment, the elastomeric material 67 includes rubber. Various rubber compounds may be used and, in some cases, different rubber compounds may be present in different areas of the drive/guide lug 48ᵢ. In other embodiments, the elastomeric material 67 may include another elastomer in addition to or instead of rubber (e.g., polyurethane elastomer). The drive/guide lugs 48₁-48_{N} may be provided on the inner side 45 in various ways. For example, in this embodiment, the drive/guide lugs 48₁-48_{N} are provided on the inner side 45 by being molded with the carcass 36.

The ground-engaging outer side 47 comprises a ground-engaging outer surface 31 of the carcass 36 and a tread pattern 40 to enhance traction on the ground. The tread pattern 40 comprises a plurality of traction projections 58₁-58_{T} projecting from the ground-engaging outer surface 31, spaced apart in the longitudinal direction of the endless track 22 and engaging the ground to enhance traction. The traction projections 58₁-58_{T} may be referred to as “tread projections” or “traction lugs”.

In this embodiment, the base 90 of the carcass 36 includes the inner surface 32 of the carcass 36 and part of the ground-engaging outer surface 31 of the carcass 36.

Each traction lug 58; has a front-to-rear dimension L_{L} in the longitudinal direction of the endless track 22 and a side-to-side dimension L_{W} in the widthwise direction of the endless track 22. In some cases, the front-to-rear dimension L_{L} may be a width of the traction lug 58ᵢ while the side-to-side dimension L_{W} may be a length of the traction lug 58ᵢ. In other cases, the front-to-rear dimension L_{L} may be a length of the traction lug 58ᵢ while the side-to-side dimension L_{W} may be a width of the traction lug 58ᵢ. In yet other cases, the front-to-rear dimension L_{L} and the side-to-side dimension L_{W} may be substantially the same. The traction lug 58ᵢ also has a height H.

The traction lugs 58₁-58_{T} may have any suitable shape. In this embodiment, each of the traction lugs 58₁-58_{T} has an elongated shape and is angled, i.e., defines an oblique angle θ (i.e., an angle that is not a right angle or a multiple of a right angle), relative to the longitudinal direction of the track 22. The traction lugs 58₁-58_{T} may have various other shapes in other examples (e.g., curved shapes, shapes with straight parts and curved parts, etc.).

In this embodiment, each traction lug 58ᵢ is an elastomeric traction lug in that it comprises elastomeric material 41. The elastomeric material 41 can be any polymeric material with suitable elasticity. More particularly, in this embodiment, the elastomeric material 41 includes rubber. Various rubber compounds may be used and, in some cases, different rubber compounds may be present in different areas of the traction lug 58ᵢ. In other embodiments, the elastomeric material 41 may include another elastomer in addition to or instead of rubber (e.g., polyurethane elastomer). The traction lugs 58₁-58_{T} may be provided on the ground-engaging outer side 47 in various ways. For example, in this embodiment, the traction lugs 58₁-58_{T} are provided on the ground-engaging outer side 47 by being molded with the carcass 36.

The drive wheel 24 is rotatable by power derived from the prime mover 14 to drive the track 22. That is, power generated by the prime mover 14 and delivered over the powertrain 15 of the agricultural vehicle 10 can rotate a final drive axle 56i, which causes rotation of the drive wheel 24, which in turn imparts motion to the track 22.

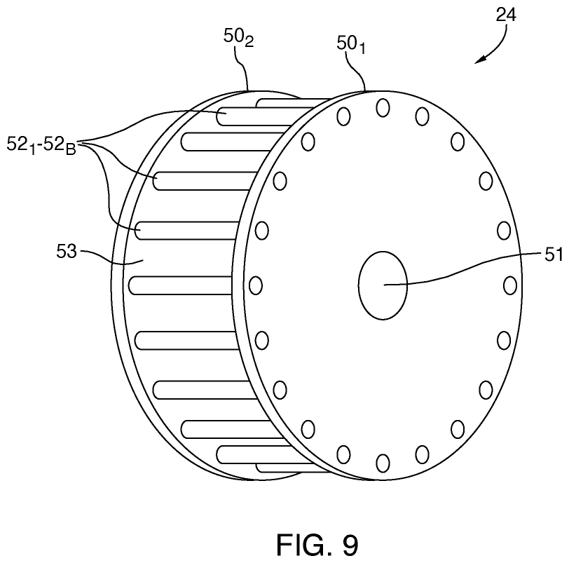

With additional reference to FIG. 9, in this embodiment, the drive wheel 24 comprises a drive sprocket comprising a plurality of drive members 52₁-52_{B} spaced apart along a circular path to engage the drive/guide lugs 48₁-48_{N} of the track 22 in order to drive the track 22. The drive wheel 24 and the track 22 thus implement a “positive drive” arrangement. More particularly, in this embodiment, the drive wheel 24 comprises two side discs 50₁-50₂ which are co-centric and turn about a common axle 51 and between which the drive members 52₁-52_{B} extend near respective peripheries of the side discs 50₁-50₂. In this example, the drive members 52₁-52_{B} are thus drive bars that extend between the side discs 50₁-50₂.

The drive wheel 24 and the track 22 have respective dimensions allowing interlocking of the drive bars 52₁-52_{B} of the drive wheel 24 and the drive/guide lugs 48₁-48_{N} of the track 22. Adjacent ones of the drive bars 52₁-52_{B} define an interior space 53 between them to receive one of the drive/guide lugs 48₁-48_{N}. Adjacent ones of the drive/guide lugs 48₁-48_{N} define an inter-lug space 39 between them to receive one of the drive bars 52₁-52_{B}. The drive/guide lugs 48₁-48_{N} and the drive bars 52₁-52_{B} have a regular spacing that allows interlocking of the drive/guide lugs 48₁-48_{N} and the drive bars 52₁-52_{B} over a certain length of the drive wheel's circumference.

The drive wheel 24 may be configured in various other ways in other embodiments. For example, in other embodiments, the drive wheel 24 may not have any side discs such as the side discs 50₁-50₂ . As another example, in other embodiments, instead of being drive bars, the drive members 52₁-52_{B} may be drive teeth that are distributed circumferentially along the drive wheel 24 or any other type of drive members. As another example, in embodiments where the track 22 comprises recesses or holes, the drive wheel 24 may have teeth that enter these recesses or holes in order to drive the track 22. As yet another example, in some embodiments, the drive wheel 24 may frictionally engage the inner side 45 of the track 22 in order to frictionally drive the track 22 (i.e., the drive wheel 24 and the track 22 may implement a “friction drive” arrangement).

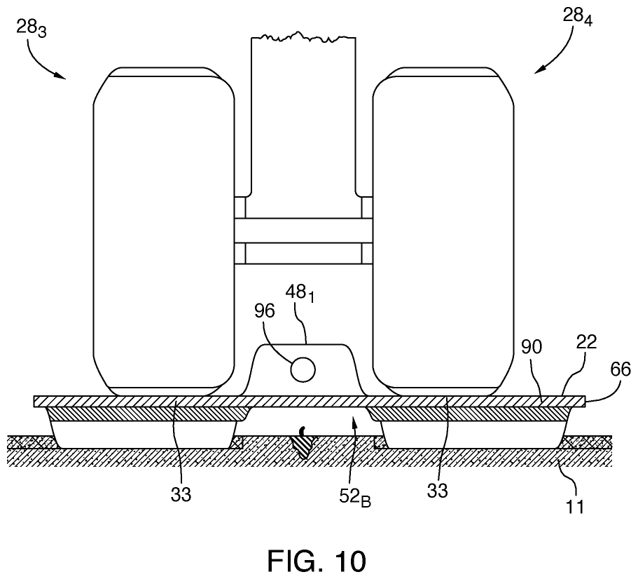

The front idler and roller wheels 26, 28₁-28₆ are not driven by power supplied by the prime mover 14, but are rather used to do at least one of supporting part of the weight of the agricultural vehicle 10 on the ground via the track 22, guiding the track 22 as it is driven by the drive wheel 24, and tensioning the track 22. More particularly, in this embodiment, the front idler wheel 26 is a leading idler wheel which maintains the track 22 in tension and help to support part of the weight of the agricultural vehicle 10 on the ground via the track 22. As shown in FIG. 10, the roller wheels 28₁-28₆ roll on a rolling path 33 of the inner side 45 of the track 22 along the bottom run 66 of the track 22 to apply the bottom run 66 on the ground.

In this case, as they are located between frontmost and rearmost ones of the wheels of the track system 16, the roller wheels 28₁-28₆ can be referred to as “mid-rollers”.

In this embodiment, the track system 16 comprises a tensioner 95 configured to control a tension of the track 22. For instance, in this embodiment, the tensioner 95 comprises an actuator mounted at one end to a first portion of the track system 16 and at another end to a second portion of the track system 16 that is movable relative to the first portion of the track system 16. More particularly, in this example, the actuator may comprise a first anchor 971 attached to a first part of the track-engaging assembly, such as the frame 13 of the track system 16 and a second anchor 972 attached to second part of the track-engaging assembly, such as a hub of the idler wheel 26 or the drive wheel 24. This allows the tensioner 95 to modify a distance between the idler wheel 26 in the longitudinal direction of the track system 16, thereby affecting the tension of the track 22. More specifically, in this embodiment, the tensioner 95 is a hydraulic tensioner.

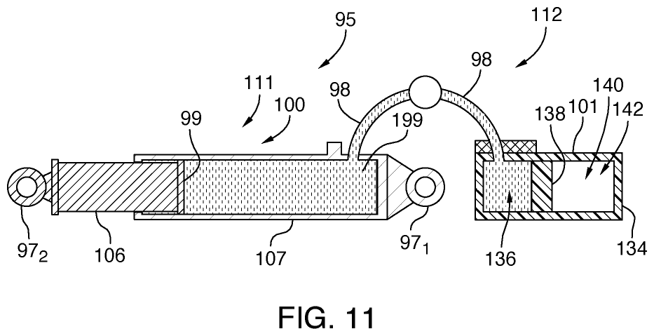

For example, with additional reference to FIG. 11, in this embodiment, the tensioner 95 comprises a first tensioning member 111 and a second tensioning member 112. More specifically, in this embodiment, the first tensioning member 111 includes a hydraulic cylinder 100 which may comprise a plurality of hydraulic cylinder elements 106, 107. The first anchor 97₁ of the tensioner 95 may be affixed to (e.g., by using a mechanical fastener, an adhesive, by being mechanically interlocked, etc.) or integral with (i.e., manufactured integrally with) the cylinder member 107, while the second anchor 97₂ may be affixed to (e.g., by using a mechanical fastener, an adhesive, by being mechanically interlocked, etc.) or integral with (i.e., manufactured integrally with) the cylinder member 106.

In this embodiment, the hydraulic cylinder elements 106, 107 are moveable relative to one another to allow the tensioner 95 to retract and/or expand. Specifically, the hydraulic cylinder elements 106, 107 may be coaxial.

In this embodiment, the hydraulic cylinder element 107 is a bore and the hydraulic cylinder element 106 is a piston moveable within its bore 107.

In this embodiment, the second tensioning member 112 comprises a hydraulic accumulator 101, which is configured to accumulate hydraulic fluid (e.g., oil) of the hydraulic cylinder 100 in an accumulation chamber 136, and which may be in fluid communication with the hydraulic cylinder 100 via a channel 98. More specifically, in this embodiment, the hydraulic accumulator 101 further comprises a housing 134 comprising the accumulation chamber 136, a piston 138 moveable relative to a housing 134 and a compressible chamber 140 formed by the housing 134 and the piston 138 and which may comprise a biasing element 142 (e.g., a spring or compressible fluid) to exert a force against the piston 138. In this embodiment, the biasing element 142 is compressible fluid, which in this example is a gas (e.g., nitrogen). The housing 134 and the piston 138 may create a hermetic joint which allows the compressible chamber 140 to hermetically contain the nitrogen at a relatively high pressure such that the nitrogen exerts a force on the piston 138 that is transferred to the hydraulic cylinder 100 via the fluid 99 flowing in the channel 98.

The tensioner 95 may be configured to apply a tension on the track 22 at any suitable nominal tension value. For instance, in some embodiments, a vibration controller or the tensioner 95 may be configured to apply a nominal tension of at least 1500 psi, in some embodiments of at least 2000 psi, in some embodiments of at least 2500 psi, and in some embodiments of even more (e.g., of at least 2900 psi).

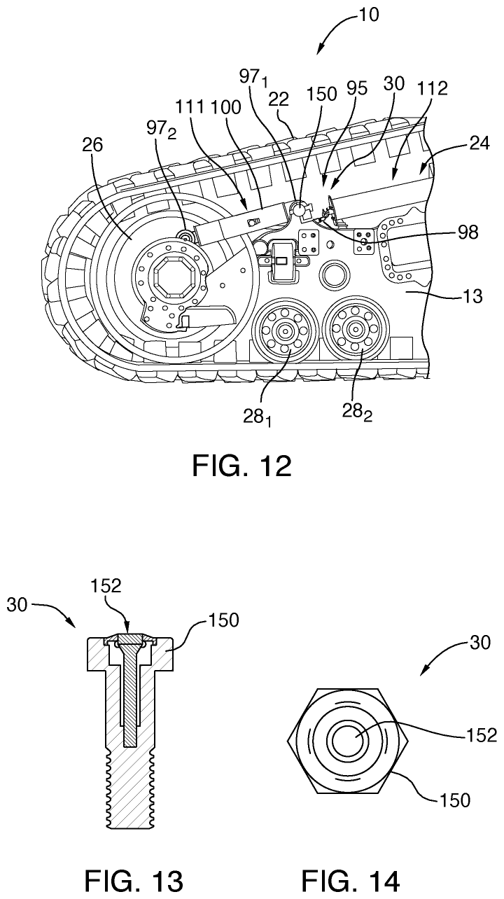

As shown in FIG. 12, in this embodiment, the track system 16 comprises an indicator 30 configured to provide an indication that is representative of the pressure of the hydraulic fluid 99 inside the tensioner 95 while reducing oil leeks, oil contamination and improving durability of the track system 16. More specifically, in this embodiment, the indicator 30 is configured to indicate a load of the tensioner 95 and is free of contact with the hydraulic fluid 99.

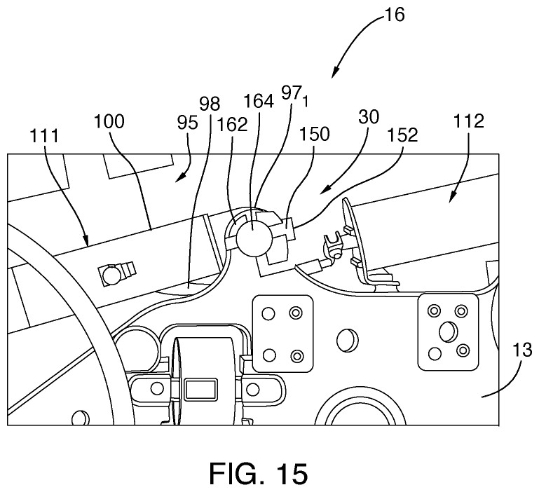

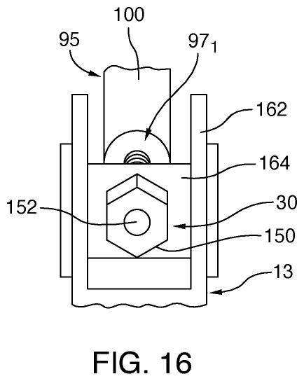

With additional reference to FIGS. 12 to 16, in this embodiment, the indicator 30 comprises a body 150 on which the tensioner 95 is configured to exert a force, a moment, or a pressure. For instance, the indicator 30 may be located and the anchor 97₁ of the hydraulic cylinder 100. The body 150 may be a bolt attaching the first anchor 97₁ of the hydraulic cylinder 100 to the frame 13 of the track system 16. More specifically, the frame 13 may comprise a bracket 162 and a pivot 164 rotatably connected to the bracket 162 and comprising a non-threaded opening configured to receive the bolt 150. The first anchor 97₁ may comprise a threaded opening configured to receive a threaded end of the bolt 150 such that the bolt 150 affixes the first anchor 97₁ to the pivot 164 of the frame 13 and rotatably connects the first anchor 97₁ to the bracket 162 of the frame 13. In this configuration, a linear load supported by the bolt 150 may correspond to the load of the tensioner 95.

The bolt 150 may comprise a surface 152 that is visible from an exterior of the track system 16 and indicating a tension and/or shear force applied to the bolt 150. For instance, the surface 152 may have a color that changes depending on the tension or shear force applied to the bolt 150. For example, SMARTBOLTS™ may be used.

The surface 152 of the indicator 30 may indicate a force applied by the tensioner 95 on the frame 13 and may be used for determining a pressure of the hydraulic fluid 99 of the tensioner 95. For instance, data may be provided to the user and depending on a size and a model of the track system 16 and/or tensioner 95, a force applied to the bolt 150 may correspond to a static pressure of the hydraulic fluid 99 of the tensioner 95. As such, the indicator 30 may provide a visual indication that is representative of the static pressure of the hydraulic fluid 99 of the tensioner 95. For instance, the surface 152 of the indicator may be configured to be orange if the static pressure of the hydraulic fluid 99 is below a predetermined operating pressure range, red if the static pressure of the hydraulic fluid 99 is within the predetermined operating pressure range, and dark if the static pressure of the hydraulic fluid 99 is above the predetermined operating pressure range.

In some embodiments, the bolt 150 may be attaching the second anchor 972 of the hydraulic cylinder 100 to the hub of the idler wheel 26 of the track system 16.

The track system 16, including the indicator 30, may be implemented in any other suitable way in other embodiments.

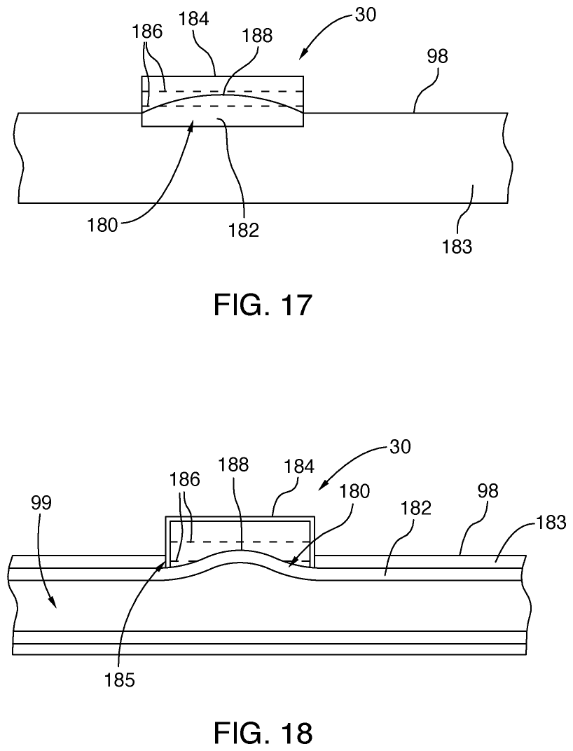

For instance, in some embodiments, as shown in FIGS. 17 and 18, the indicator 30 may comprise a resilient portion 180 that is resiliently deformable when a pressure, a load or a moment is applied thereon. That is, the resilient portion 180 may be configured to deform with the pressure, load or moment is applied thereon, and may recover an initial shape with the pressure, load or moment is removed.

In this example, the resilient portion 180 is provided on the channel 98 and comprises a resilient material 180. More specifically, the resilient material 182 is an elastomeric material. More specifically, the resilient material 182 comprises rubber.

The resilient portion 180 may be defined by an aperture 185 of a rigid material 183 of the channel 98 that is more rigid than the resilient material 182.

In this embodiment, the resilient portion 180 of the indicator 30 is covered by a protective transparent cover 184 allowing the user to observe a deformation of the resilient portion 180 under the pressure of the fluid 99. In this example, the cover 184 comprises marks 186 defining a range between which an apex 188 of the resilient portion should be located. An apex 188 below the range may indicate that a pressure of the fluid 99 is too low, while an apex over the range may indicate that the pressure of the fluid 99 is too high.

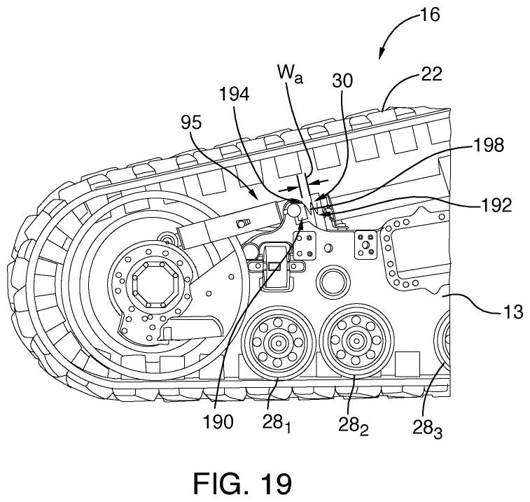

As another example, in some embodiments, as shown in FIG. 19, the frame 13 may comprise a first portion 190 that is resiliently deformable and that is proximate to a second portion 192 that is stiffer and does not deform substantially under the load of the tensioner 95. In this example, the indicator 30 may comprise a gap 194 between the resilient portion 190 and the rigid portion 192. In particular, the first anchor 97₁ of the tensioner 95 may be rotatably attached to the resilient portion 190 by any suitable means (e.g., using a pivot), thus deforming the resilient portion 190, and a width W_{G} of the gap 194 may be representative of the static pressure of the hydraulic fluid 99 of the tensioner 95. For instance, a width W_{G} that is greater than a predetermined range may indicate that the static pressure of the hydraulic fluid 99 of the tensioner 95 is too low and, inversely, a width W_{G} below the pre-determined range may indicate that the static pressure of the hydraulic fluid 99 of the tensioner 95 is too low. In this embodiment, the indicator 30 may comprise a spring 198 connecting the portions 190, 192.

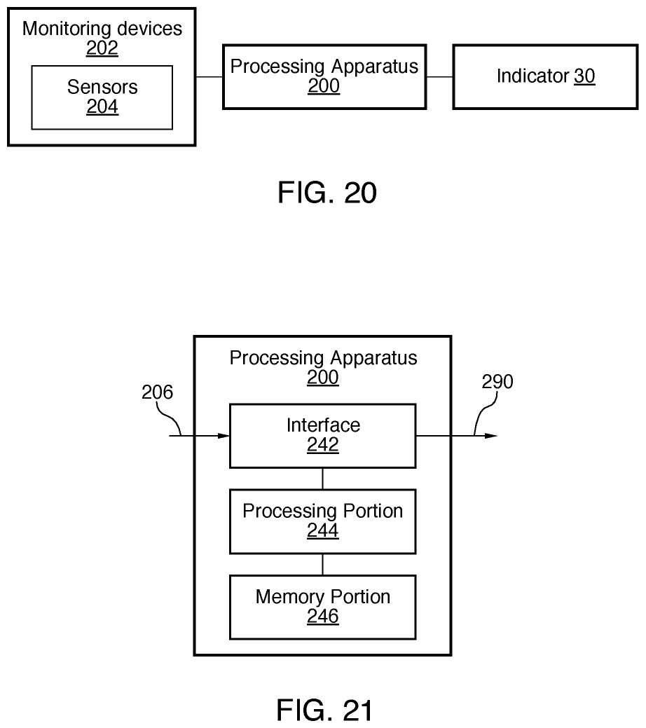

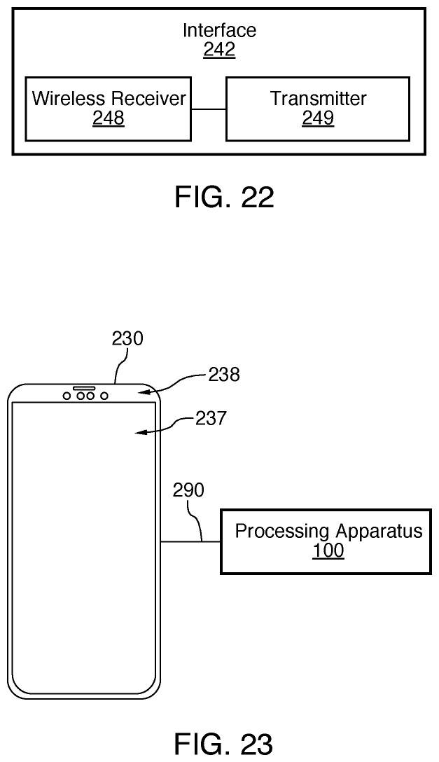

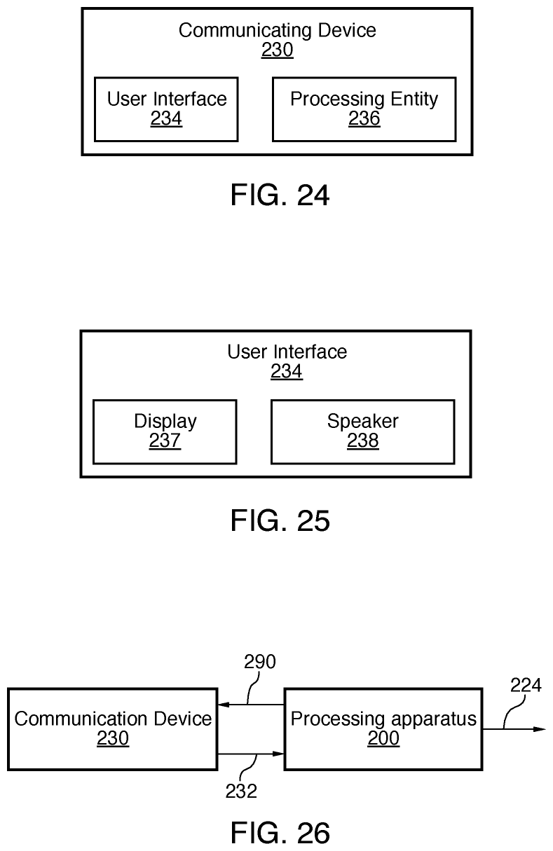

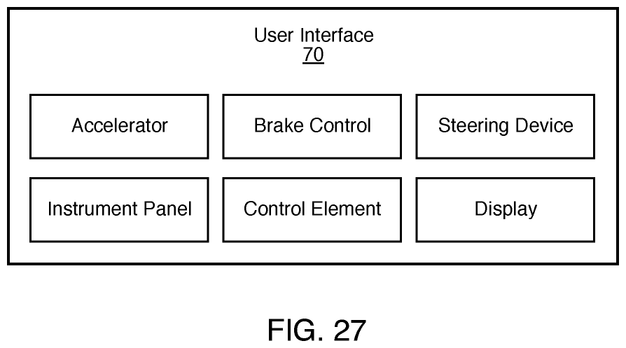

As another example, as shown in FIGS. 20 to 27, in some embodiments, the vehicle 10 may comprise a processing apparatus 200 and the track assembly 30 may comprise monitoring devices 202, such as sensors 204 and/or other monitoring devices (e.g., cameras), for sensing and/or otherwise monitoring parameters of the vehicle 10, of the track system 16 and/or its environment (e.g., the ground). The processing apparatus 200 may be in communication with the monitoring devices 202 and configured to generate a signal 290 relating to the static pressure of the hydraulic fluid 99 and/or to operating conditions of the track system 16.

The sensors 204 may be configured to generate a signal 206 relating to the sensed parameter of the sensors 204 and convey the signal 206 to the processing apparatus 200. The sensors 204 may be configured to convey the signal 206 to the processing apparatus 200 by any suitable means. For instance, in some cases, the signal 206 may be conveyed to the processing apparatus 200 using one or more wires. In some cases, the signal 206 may be conveyed to the processing apparatus 200 wirelessly, e.g., using a Bluetooth® protocol, over a Wi-Fi network, over a 5G network, etc. More specifically, the processing apparatus 200 may be configured to process the signal 206 relating to the sensed parameter and generate the signal 290 relating to the static pressure of the hydraulic fluid 99 and/or to operating conditions of the track system 16, and the signal 290 may convey information derived by processing the characteristic to the indicator 30. For example, in some embodiments, the indicator 30 can be an electronic pressure transducer connected to a hydraulic port in the tensioner 95. The electronic pressure transducer can be configured to send the signal 206 to the processing apparatus 200. In some embodiments, the signal 206 can comprise an electrical signal indicating the pressure level of the tensioner 95.

The sensors 204 used in practical implementations may include various suitable types of sensors. For instance, the sensors 204 may comprise a pressure sensor to sense pressure, a load cell or a load pin to sense a load, an accelerometer to sense an acceleration, a strain gauge to sense a deformation, a force sensor to sense a force, and so on.

In this embodiment, the processing apparatus 200 comprises an interface 242, a processing portion 244, and a memory portion 246, which are implemented by suitable hardware and/or software.

The interface 242 comprises one or more inputs and outputs allowing the processing apparatus 220 to receive input signals from and send output signals to other components to which the processing apparatus 220 is connected (i.e., directly or indirectly connected), including, in this embodiment, the sensor 204. For example, in this embodiment, an input of the interface 242 is implemented by a wireless receiver 248 to receive a sensor signal from the sensor 204. An output of the interface 242 is implemented by a transmitter 249 to transmit the signal 290.

The processing portion 244 comprises one or more processors for performing processing operations that implement functionality of the processing apparatus 220. A processor of the processing portion 244 may be a general-purpose processor executing program code stored in the memory portion 246. Alternatively, a processor of the processing portion 244 may be a specific-purpose processor comprising one or more preprogrammed hardware or firmware elements (e.g., application-specific integrated circuits (ASICs), electrically erasable programmable read-only memories (EEPROMs), etc.) or other related elements.

The memory portion 246 comprises one or more memories for storing program code executed by the processing portion 244 and/or data used during operation of the processing portion 244. The memory portion 246 could also be used for storing data (e.g., temperature readings, reference temperatures). A memory of the memory portion 246 may be a semiconductor medium (including, e.g., a solid-state memory), a magnetic storage medium, an optical storage medium, and/or any other suitable type of memory. A memory of the memory portion 246 may be read-only memory (ROM) and/or random-access memory (RAM), for example.

In some embodiments, two or more elements of the processing apparatus 220 may be implemented by devices that are physically distinct from one another and may be connected to one another via a bus (e.g., one or more electrical conductors or any other suitable bus) or via a communication link which may be wired, wireless, or both. In other embodiments, two or more elements of the processing apparatus 220 may be implemented by a single integrated device. In some embodiments, at least part of the processing apparatus 220 in integrated into a remote device such as a smartphone or a remote computer.

In some embodiments, the indicator 30 may comprise a light device configured to emit light depending on the sensed parameter of the monitoring devices 202. The light device may comprise one or more light emitting diode (“LED”) which may be located on part of the track system 16 (e.g., on the tensioner 95, on the frame 13, etc.), on the user interface 70 of the operator cabin 20 of the vehicle 10, or on a remote device. For instance, the light device may comprise a green-colored LED that is configured to be turned on when the sensed parameter of the monitoring devices 202 is within a pre-determined range, and a red-colored LED that is configured to be turned on when the sensed parameter of the monitoring devices 202 is outside the pre-determined range.

In other embodiments, the indicator 30 may be implemented by a communication device 130 and the signal 290 generated by the processing device 220 may be directed to and transmitted to the communication device 230 for conveying information to a user of the communication device 230. More specifically, in this example, the communication device 230 may comprise the user interface 234 (e.g., a graphical user interface) for interacting with a user and a processing entity 236 for processing the signal 292 and generate a suitable user interaction depending on the signal 292. In this embodiment, the user interface 234 comprises a display 237 for displaying the information to the user and a speaker 238 for alerting the user of a notification or an alert.

In some embodiments, the communication device 230, including the user interface 134 may be part of a user interface 70 of the operator cabin 20. In other embodiments, the communication device 230 may a device separate from the operator cabin 20. The communication device 230 may be any suitable device and may be, for instance, one of: a computer, a smartphone, a laptop, a tablet computer and a phablet, on which an app has been downloaded so as to interact with the monitoring system 200. In this example, the signal 292 may be configured to push notifications to the communication device 230 when the characteristic sensed by the sensors 204 attains a threshold value.

The information conveyed by the communication device 230 may comprise an indication of a sensed parameter of the monitoring devices 202, and/or a notification related to the static pressure of the hydraulic fluid 99. In this example, the notification may notify of an adjustment to be made to adjust an equipment setting (e.g., a pressure adjustment of the tensioner 95), indicate a magnitude of the adjustment to be made, request an authorization from the user to automatically adjust said equipment setting, notify of potential damage to the tensioner 95, track system 16 and/or the vehicle 10, etc. Different examples of the implementation of the processing apparatus 200 and monitoring devices are provided below.

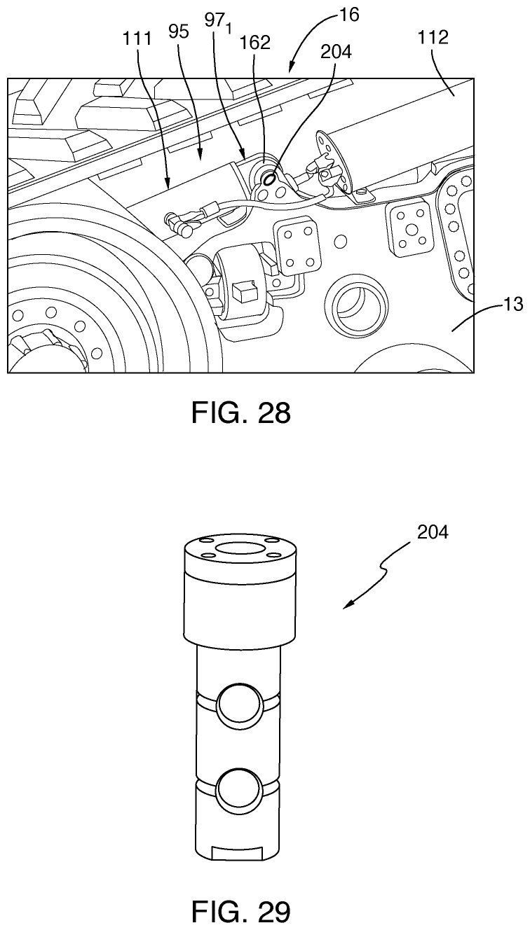

For instance, in some embodiments, as shown in FIGS. 28 and 29, at least one of the sensors 204 is a load pin connecting a given one of the first and second anchors 97₁, 97₂ to a corresponding part of the track engaging assembly 21 (for example, the frame 13 or the drive wheel 26, respectively). In this example, the first anchor 97₁ of the cylinder 100 may comprise an opening, the frame 13 may comprise brackets, such as bracket 162, having a similar opening and the sensor 204 that is a load pin may be inserted through the openings and secured longitudinally to rotatably connect the anchor 97₁ of the cylinder 100 to the brackets 162 of the frame 13. The sensor 204 that is a load pin may be configured to measure a force applied by the tensioner 95 and the processing apparatus 200 may be configured to associate the force sensed by the sensor 204 that is a load pin to a static pressure of the hydraulic fluid 99 and the indicator 30 may convey an indication relative to the static pressure of the hydraulic fluid 99.

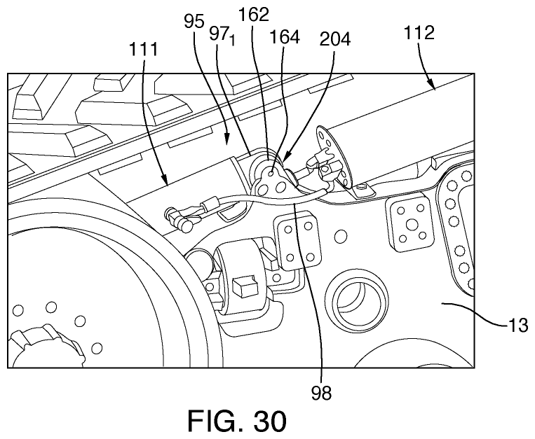

In some embodiments, as shown in FIG. 30, at least one of the sensors 204 is a strain gauge installed at a given one of the first and second anchors 97₁, 97₂. In this example, the first anchor 97₁ of the cylinder 100 may comprise an opening, the frame 13 may comprise brackets 162 having a similar opening and a pivot 164 may be inserted through the openings and secured longitudinally to rotatably connect the first anchor 97₁ of the cylinder 100 to the brackets 162 of the frame 13. One of the openings may be slightly oversized in order to fit the sensor 204 that is a strain gauge between a periphery of the opening and the pivot 164. In this configuration, the sensor 204 that is a strain gauge may be configured to measure a force applied by the tensioner 95 and the processing apparatus 200 may be configured to associate the force sensed by the sensor 204 that is a strain gauge to a static pressure of the hydraulic fluid 99 and the indicator 30 may convey an indication relative to the static pressure of the hydraulic fluid 99.

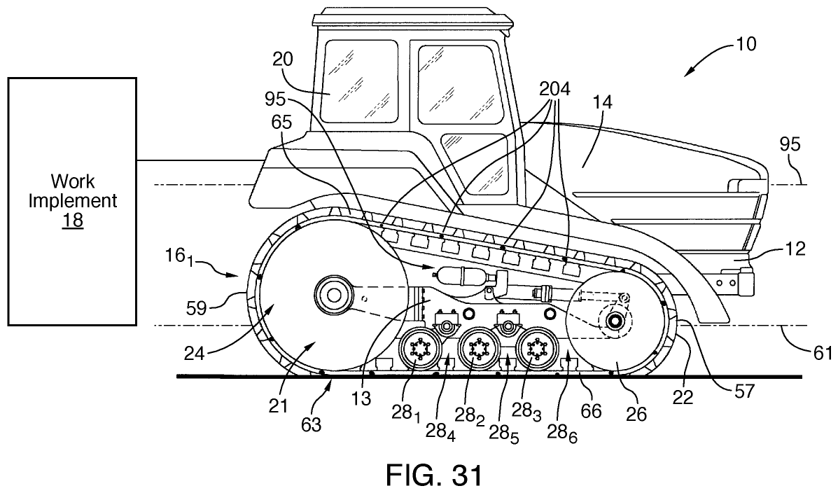

In some embodiments, as shown in FIG. 31, at least one of the sensors 204 is an accelerometer embedded in the track 22. In this example, the sensor 204 that is an accelerometer may be embedded in the carcass 36 of the track 22 during molding of the track 22. The sensor 204 that is an accelerometer may be configured to measure an acceleration of the track and the processing apparatus 200 may be configured to associate the acceleration of the track 22 with a resonance frequency of the track 22, with a corresponding tension of the track 22 (which characterizes the resonance frequency of the track 22) and with a static pressure of the hydraulic fluid 99. The indicator 30 may convey an indication relative to the static pressure of the hydraulic fluid 99.

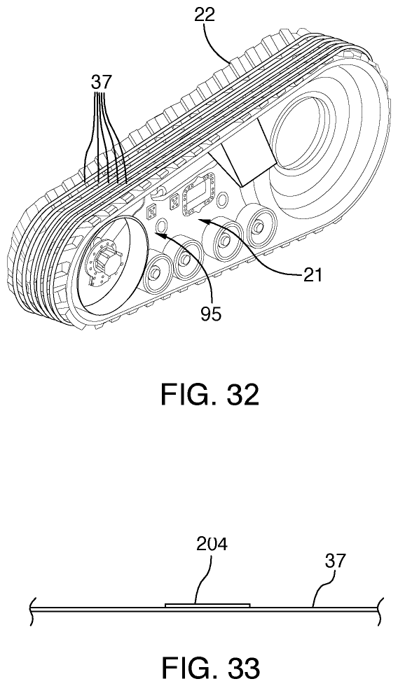

In some embodiments, as shown in FIGS. 32 and 33, the track 22 may comprise longitudinal cables 37 that impart a majority of a longitudinal stiffness of the track 22, and the at least one of the sensors 204 is strain gauge embedded in the track 22 and configured to measure an elongation of the cables 37 of the track 22. The cables 37 may be made of a relatively rigid material, such as steel. The processing apparatus 200 may be configured to associate the elongation longitudinal components of the track 22 with a corresponding tension of the track and with a static pressure of the hydraulic fluid 99. The indicator 30 may convey an indication relative to the static pressure of the hydraulic fluid 99.

Although the agricultural vehicle 10 illustrated in FIG. 1 is an agricultural tractor comprising two track systems 16, different types of agricultural vehicles configured differently (e.g., having a different number of track systems) may implement improvements based on principles disclosed herein.

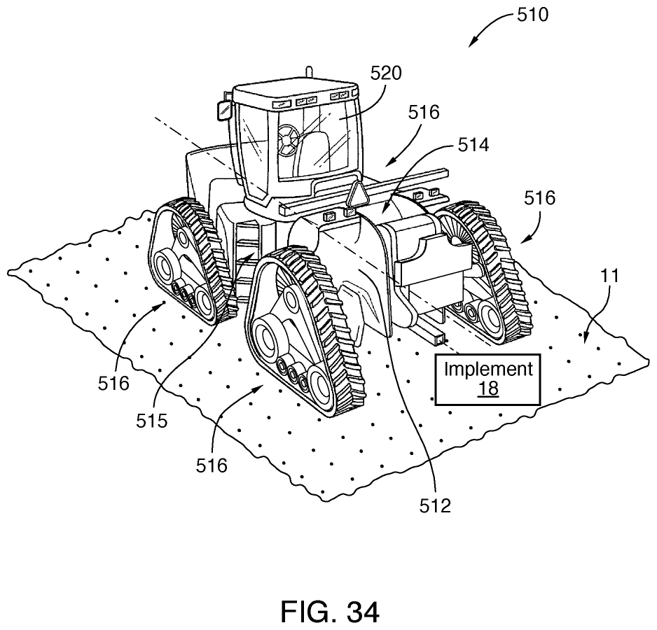

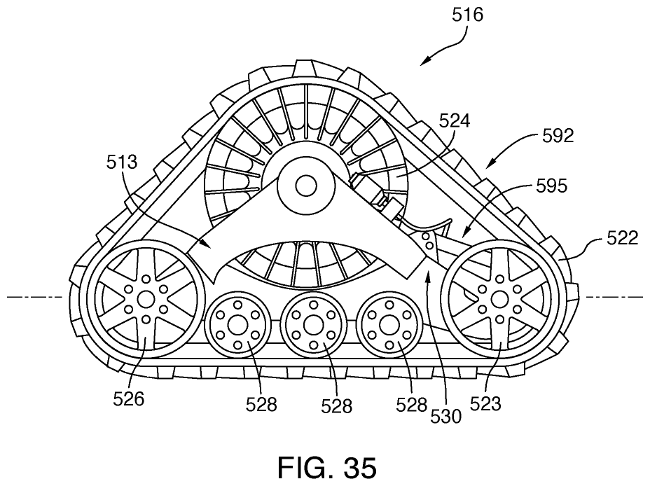

For instance, with additional reference to FIGS. 34 and 35, an agricultural vehicle 510 may be provided comprising four track systems 516 rather than two (i.e., two track systems 516 at each side of the agricultural vehicle 510). The agricultural vehicle 510 also comprises a frame 512, a prime mover 514, a powertrain 515 and an operator cabin 520 and can be equipped with the work implement 18 to perform agricultural work. Each track system 516 comprises a frame 513, a drive wheel 524, a front idler wheel 523 at a first longitudinal end portion of the track system 516, a rear idler wheel 526 at a second longitudinal end portion of the track system 516 opposite to the first longitudinal end portion, and a plurality of mid-rollers 528 intermediate the drive wheel 524 and the idler wheel 526. The track system 516 further comprises a track 522 disposed around the wheels 524, 526, 528 and driven by the drive wheel 524. Each track system 516 may comprise a tensioner 595, an indicator 530 and optionally monitoring devices 592 configured in a manner similar to the tensioner 95, indicator 30 and monitoring devices 202 as described above.

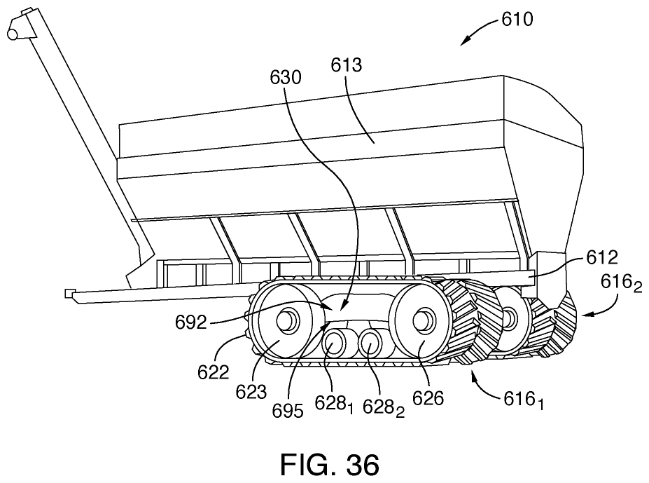

Furthermore, the work implement 18 that is drawn by the agricultural vehicle 10 or the agricultural vehicle 510 may implement the improvements disclosed herein. For instance, with additional reference to FIG. 36, the work implement 18 may comprise a trailed vehicle 610 comprising a frame 612, a body 613 (e.g., a container) and track systems 6161, 6162. In this example, the trailed vehicle 610 is a harvest cart. In other examples, the trailed vehicle 610 may be a fertilizer cart, a sprayer, a planter or any other suitable type of trailed vehicle. Each track system 616 of the trailed vehicle 610 comprises front (i.e., leading) idler wheels 623 at a first longitudinal end portion of the track system 616, rear (i.e., trailing) idler wheels 626 at a second longitudinal end portion of the track system 616 opposite the first longitudinal end portion, and a plurality of mid-rollers 628₁, 628₂ intermediate the front idler wheels 623 and the rear idler wheels 626. The track system 616 further comprises a track 622 disposed around the front idler wheel 623, the plurality of mid-rollers 628₁, 628₂, and the rear idler wheel 626. Each track system 616 may comprise a tensioner 695, an indicator 630 and optionally monitoring devices 692 configured in a manner similar to the tensioner 95, indicator 30 and monitoring devices 202 as described above.

In this example, the trailed vehicle 610 is not motorized in that it does not comprise a prime mover for driving the track systems 6161, 6162. Rather, the trailed vehicle 610 is displaced by the agricultural vehicle 10 or the agricultural vehicle 510 to which the trailed vehicle 610 is attached. However, in some examples, the trailed vehicle 610 may be motorized. That is, the trailed vehicle 610 may comprise a prime mover for driving a drive wheel of each track system 616. For example, instead of each track system 616₁, 616₂ comprising a rear idler wheel 626, the track systems 6161, 6162 may comprise a drive wheel for driving the track 622.

Although in embodiments considered above the vehicles 10, 510 are agricultural vehicles operable by a user from the operator cabin 20, 520, respectively, in some embodiments, the vehicles 10, 510 may be operable by a user remotely. In some embodiments, the vehicles 10, 510 may comprise autonomy features, allowing the vehicles 10, 510 to be semiautonomous and/or entirely autonomous. In some embodiments, the vehicles 10, 510 may be free of any operator cabin 20, 520, respectively.

While in embodiments considered above the vehicles 10, 510 are agricultural vehicles, in other embodiments, the vehicles 10, 510 may be industrial vehicles such as a construction vehicle (e.g., a loader, a telehandler, a bulldozer, an excavator, etc.) for performing construction work or a forestry vehicle (e.g., a feller-buncher, a tree chipper, a knuckleboom loader, etc.) for performing forestry work, a military vehicle (e.g., a combat engineering vehicle (CEV), etc.) for performing military work, an all-terrain vehicle (ATV), a snowmobile, or any other vehicle operable off paved roads. Although operable off paved roads, the vehicles 10, 510 may also be operable on paved roads in some cases.

In some examples of implementation, any feature of any embodiment described herein may be used in combination with any feature of any other embodiment described herein.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

In case of any discrepancy, inconsistency, or other difference between terms used herein and terms used in any document incorporated by reference herein, meanings of the terms used herein are to prevail and be used.

Although various embodiments and examples have been presented, this was for purposes of description, but should not be limiting. Various modifications and enhancements will become apparent to those of ordinary skill in the art.

1. A track system for a vehicle, the track system comprising:
a track that comprises a ground-engaging outer surface and an inner surface opposite to the ground-engaging outer surface;
a track-engaging assembly comprising a plurality of track-contacting wheels configured to drive and guide the track around the track-engaging assembly;
a tensioner configured to control a tension of the track, the tensioner comprising a hydraulic cylinder and a hydraulic accumulator in fluid communication with the hydraulic cylinder and configured to receive hydraulic fluid; and
an indicator configured to indicate a load of the tensioner.

2. The track system of claim 1, wherein the indicator is configured to convey information related to a static pressure of the tensioner based on a measurement that is different from a measurement of the static pressure of the tensioner.

3. The track system of claim 1, wherein the indicator comprises one of:
a body and the tensioner is configured to exert one of: a force, a moment, and a pressure on the body; and
a resilient portion configured to resiliently deform when a pressure, a load, or a moment is applied on the resilient portion.

4. The track system of claim 3, wherein the indicator comprises the body and the body comprises a bolt comprising a surface that is visible from an exterior of the bolt and that is configured to change color depending on the force, the moment, or the pressure on the bolt.

5. The track system of claim 4, wherein the bolt couples the tensioner to a corresponding part of the track-engaging assembly.

6. The track system of claim 1, wherein the hydraulic cylinder comprises: a first anchor at a first end of the hydraulic cylinder and being coupled to a first part of the track-engaging assembly; and a second anchor at a second end of the hydraulic cylinder and being coupled to a second part of the track-engaging assembly, the second part of the track-engaging assembly being moveable relative to the first part of the track-engaging assembly.

7. The track system of claim 6, wherein the indicator is located at a given one of the first anchor and/or the second anchor of the tensioner.

8. The track system of claim 6, wherein the first part of the track-engaging assembly comprises a frame of the track-engaging assembly and the indicator comprises a gap between: a first portion of the frame that is coupled to the first anchor and resiliently deformable and a second portion of the frame.

9. The track system of claim 8, wherein the indicator comprises a spring in the gap.

10. The track system of claim 1, further comprising at least one sensor in communication with the indicator or the tensioner and configured to sense a parameter of the track system, wherein the at least one sensor is at least one of: a pressure sensor, a load cell, a load pin, an accelerometer, a strain gauge, and a force sensor.

11. The track system of claim 1, wherein the tensioner further comprises a channel to fluidly connect the hydraulic cylinder with the hydraulic accumulator.

12. The track system of claim 1, wherein the hydraulic accumulator comprises a housing, wherein the housing comprises: an accumulation chamber, a piston moveable relative to the housing, a compressible chamber formed by the housing and the piston, and a biasing element to exert a force against the piston.

13. The track system of claim 12, wherein the biasing element comprises a spring or a compressible fluid.

14. The track system of claim 13, wherein the compressible chamber hermetically contains the compressible fluid and the compressible fluid comprises nitrogen.

15. The track system of claim 1, wherein the tensioner is configured to apply the tension on the track at a nominal tension value of at least 1500 psi, at least 2000 psi, or at least 2500 psi.
